(19) United States
(12) Patent Application Publication
(10) Pub. No.: US 2019/0315500 A1
(43) Pub. Date: Oct. 17, 2019

(54) THERMALLY-ENHANCED AND DEPLOYABLE STRUCTURES

(71) Applicant: Raytheon Company, Waltham, MA (US)

(72) Inventors: Tuan L. Duong, Santa Barbara, CA (US); Adam D. Leeds, Santa Barbara, CA (US); James E. Benedict, Tewksbury, MA (US)

(21) Appl. No.: 16/385,546

(22) Filed: Apr. 16, 2019

Related U.S. Application Data
(60) Provisional application No. 62/658,932, filed on Apr. 17, 2018.
(60) Provisional application No. 62/718,168, filed on Aug. 13, 2018.

(51) Int. Cl. B64G 1/58; F28F 5/00; F42B 15/34; B64G 1/10; F03G 7/06

(52) U.S. Cl. CPC B64G 1/58; F28F 5/00; F28F 2255/04; B64G 1/10; F03G 7/065; F42B 15/34

(57) ABSTRACT

A system includes a flight vehicle and one or more deployable radiators. Each deployable radiator includes a structure configured to receive thermal energy and to reject the thermal energy into an external environment. The structure includes (i) multiple inline and interconnected thermomechanical regions and (ii) one or more thermal energy transfer devices embedded in at least some of the thermomechanical regions. The one or more thermal energy transfer devices are configured to transfer the thermal energy between different ones of the thermomechanical regions. At least one of the thermomechanical regions includes one or more shape-memory materials configured to cause a shape of the structure to change. The thermomechanical regions may include one or more heat input regions configured to receive the thermal energy, one or more heat rejection regions configured to reject the thermal energy into the external environment, and one or more morphable regions including the one or more shape-memory materials and configured to change shape.

### CROSS-REFERENCE TO RELATED APPLICATIONS AND PRIORITY CLAIM

This application claims priority under 35 U.S.C. § 119(e) to U.S. Provisional Patent Application No. 62/658,932 filed on Apr. 17, 2018 and U.S. Provisional Patent Application No. 62/718,168 filed on Aug. 13, 2018.

### TECHNICAL FIELD

This disclosure is generally directed to thermal management systems. More specifically, this disclosure is directed to thermally-enhanced and deployable structures.

### BACKGROUND

Various flight vehicles, such as satellites that are deployed in space, have highly-constrained size, weight, and power (SWaP) requirements. For example, the design of a satellite often must meet restrictions placed on the size, weight, and power of the satellite in order to ensure proper delivery of the satellite into a desired orbit and to ensure proper operation of the satellite once deployed. These requirements can make packaging electronics into a flight vehicle very challenging. Among other things, a system-level thermal budget identifies the maximum amount of thermal energy (heat) that can be generated by components in a flight vehicle and removed by a thermal management system of the flight vehicle. The thermal budget can therefore limit the payload carried by the flight vehicle and the power density of those electronics.

Various thermal management systems for use in flight vehicles have been proposed. Some thermal management systems support passive heat dissipation, such as by sinking waste heat into a static single wall that then functions as a radiator. Optionally, passively-deployed tape spring hinges can be used to actuate or deploy the radiator in order to increase the surface area of the radiator. Other thermal management systems actively increase the surface area of a radiator. This can be accomplished using harnessing, electronics, electrical power, actuators/motors, and high thermal conductivity interconnects. Unfortunately, these approaches tend to occupy a significant amount of space, which can reduce the amount of payload carried by a flight vehicle.

### SUMMARY

This disclosure provides thermally-enhanced and deployable structures.

In a first embodiment, an apparatus includes a structure configured to receive thermal energy and to reject the thermal energy into an external environment. The structure includes (i) multiple inline and interconnected thermomechanical regions and (ii) one or more thermal energy transfer devices embedded in at least some of the thermomechanical regions. The one or more thermal energy transfer devices are configured to transfer the thermal energy between different ones of the thermomechanical regions. At least one of the thermomechanical regions includes one or more shape-memory materials configured to cause a shape of the structure to change.

In a second embodiment, a system includes a flight vehicle and one or more deployable radiators. Each deployable radiator includes a structure configured to receive thermal energy and to reject the thermal energy into an external environment. The structure includes (i) multiple inline and interconnected thermomechanical regions and (ii) one or more thermal energy transfer devices embedded in at least some of the thermomechanical regions. The one or more thermal energy transfer devices are configured to transfer the thermal energy between different ones of the thermomechanical regions. At least one of the thermomechanical regions includes one or more shape-memory materials configured to cause a shape of the structure to change.

In a third embodiment, a method includes receiving thermal energy at a structure. The structure includes (i) multiple inline and interconnected thermomechanical regions and (ii) one or more thermal energy transfer devices embedded in at least some of the thermomechanical regions. The method also includes transferring the thermal energy between different ones of the thermomechanical regions using the one or more thermal energy transfer devices. The method further includes rejecting the thermal energy from the structure into an external environment. At least one of the thermomechanical regions includes one or more shape-memory materials configured to cause a shape of the structure to change.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A and 1B illustrate an example thermally-enhanced and deployable structure in accordance with this disclosure;

FIG. 2 illustrates an example cross-section of the thermally-enhanced and deployable structure shown in FIGS. 1A and 1B in accordance with this disclosure;

FIGS. 3A and 3B illustrate another example thermally-enhanced and deployable structure in accordance with this disclosure;

FIG. 4 illustrates an example cross-section of a lid of the thermally-enhanced and deployable structure shown in FIGS. 3A and 3B in accordance with this disclosure;

FIGS. 5A and 5B illustrate a first example use of thermally-enhanced and deployable structures in accordance with this disclosure;

FIGS. 6A through 6D illustrate a second example use of thermally-enhanced and deployable structures in accordance with this disclosure;

FIGS. 7A and 7B illustrate a third example use of thermally-enhanced and deployable structures in accordance with this disclosure;

FIG. 8 illustrates a first example method for using a thermally-enhanced and deployable structure in accordance with this disclosure; and

FIG. 9 illustrates a second example method for using a thermally-enhanced and deployable structure in accordance with this disclosure.

### DETAILED DESCRIPTION

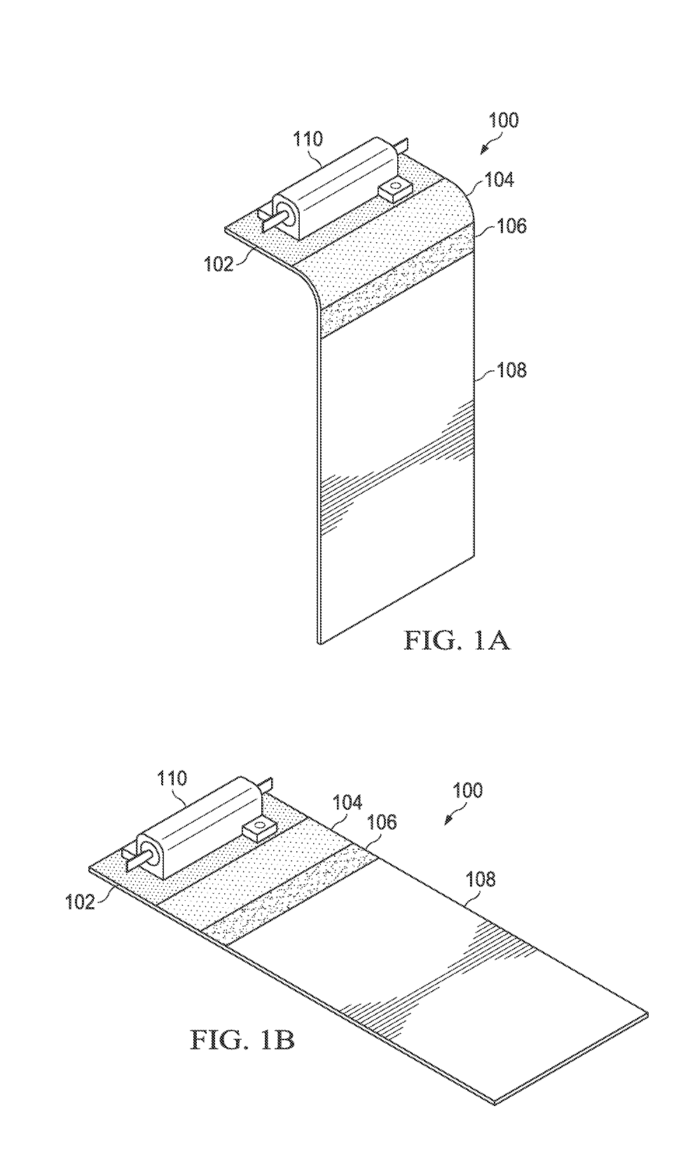

FIGS. 1A through 9, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, flight vehicles, such as satellites deployed for use in space, often have highly-constrained size, weight, and power (SWaP) requirements. Conventional passive and actively-facilitated heat transport and heat dissipation mechanisms used in flight vehicles tend to occupy a significant amount of space within those flight vehicles. This can reduce the amount of payload carried by the flight vehicles, which can also reduce the functionality provided by the payload.

This disclosure provides various approaches that integrate one or more shape-memory alloys or other shape-memory material(s) with one or more oscillating heat pipes or other thermal energy transfer mechanism(s). Materials like copper-aluminum-nickel (CuAlNi) alloys and nickel-titanium (NiTi) alloys exhibit properties such as a shape-memory effect and super-elasticity. The shape-memory effect generally refers to the ability of a material to be “programmed” with an initial shape, subsequently deformed, and then “self-reformed” back to its initial shape upon heating above its transformation temperature.

Shape-memory alloys (such as CuAlNi or NiTi alloys) have relatively low thermal conductivities when compared to aluminum/copper alloys and heat pipes. To help compensate for their low thermal conductivities, one or more shape-memory materials are integrated with one or more oscillating heat pipes (OHPs) or other thermal energy transfer mechanism(s) in accordance with this disclosure. An oscillating heat pipe typically represents a serpentine or other tube or passageway that transports heat through phase changes and motion of liquid slugs and vapor bubbles. Oscillating heat pipe technology enables a wide variety of structural materials to have increased thermal conductivities without requiring integrated wicks, which are often found in conventional heat pipe technologies.

For actively- and passively-deployed waste heat radiators, actuators and power and tape springs are often utilized. In the sense of heat transfer, these components enable augmented heat transfer but are often not situated directly in the thermal transfer path due to their low heat transfer capabilities. As a result, there is an inherent SWaP penalty associated with the use of these techniques. In accordance with this disclosure, the approaches described in this patent document enable multi-functionality by placing one or more actuators directly in one or more heat transfer paths of a deployable waste heat radiator. Moreover, the one or more actuators used here can represent one or more thermally-augmented shape-memory actuators, meaning the shape-memory actuator(s) can be integrated with one or more oscillating heat pipes or other thermal energy transfer mechanism(s). In some cases, the shape-memory actuator(s) can be passively activated by the same low-quality waste heat that is to be ultimately rejected. The waste heat can, for instance, come from a payload of a flight vehicle, such as a satellite, rocket, or missile. These types of approaches can decrease the SWaP in a given system since the heat dissipation mechanisms are passive and do not rely on external mechanisms, supplemental power, and electronics for deployment. This also presents a simplified approach for enabling passively-deployable structural members. However, it is also possible to use active mechanisms with the deployable structural members.

In some embodiments of this disclosure, one or more plates of at least one shape-memory alloy or other shape-memory material(s) (such as CuAlNi or NiTi) are programmed into an appropriate deployed position, such as by employing standard shape-memory material processing techniques. The one or more plates are then deformed as necessary or used in their current form during OHP manufacturing as structural members, which will be used to confine a working fluid in one or more oscillating heat pipes for proper operation. This forms a deployable radiator that can be integrated into a larger system. At system-level integration, the deployable radiator can be deformed into a stowed position prior to launch or other use. In some embodiments, after launch (such as subsequent to orbital insertion for a satellite), waste heat generated from electronics during initial system startup or at other times supplies the needed heat for OHP operation. The heat energy is absorbed by the shape-memory plate(s), and the radiator returns to its original programmed state. During system runtime, the deployable radiator continues to reject waste heat generated by the electronics for its intended lifetime. As noted in this document, however, other heat (including from one or more active sources) can be used with the deployable radiator.

The approaches described in this patent document therefore allow the integration of one or more shape-memory alloys or other shape-memory material(s) with one or more oscillating heat pipes or other thermal energy transfer mechanism(s) to create passively-deployable or actively-deployable waste heat radiators for satellite applications or other applications. Various novels aspects of these approaches include:

combining one or more shape-memory alloys or other shape-memory material(s) with one or more oscillating heat pipes or other thermal energy transfer mechanism(s) to increase the thermal conductivity of the shape-memory material(s);

utilizing passive or active activation of a shape-memory system in a deployable waste heat radiator system;

utilizing waste heat directly from payload electronics or other source(s) to do meaningful work, since OHP technology or other thermal energy transfer technology can enable long-range communication of heat from electronics or other sources to areas of interest (such as for dual use, like a shape-memory actuator hinge and a flat radiator exposed to deep space); and

achieving SWaP savings due to placing each actuator in line with a heat transfer path to a heat radiator.

Additional details of example embodiments of these approaches are provided below. It should be noted that these details relate to specific implementations of devices and systems that utilize these approaches and that other implementations of devices and systems can vary as needed or desired. For example, while the description below may use specific examples of materials to form one or more deployable waste heat radiators, other suitable materials can be used. As another example, while the description below may describe specific uses of one or more deployable waste heat radiators, the deployable waste heat radiators can be used in any other suitable applications. It should also be noted here that while often described as integrating one or more shape-memory materials with one or more oscillating heat pipes or other thermal energy transfer mechanisms, one or more non-shape-memory materials can also be used in a deployable radiator or other structure along with the one or more shape-memory materials. Thus, for instance, at least one portion of a deployable radiator or other structure can be formed using one or more shape-memory materials, and at least one other portion of the deployable radiator or other structure can be formed using one or more non-shape-memory materials.

FIGS. 1A and 1B illustrate an example thermally-enhanced and deployable structure 100 in accordance with this disclosure. In particular, FIG. 1A illustrates an example stowed or pre-deployment shape of the structure 100, and FIG. 1B illustrates an example deployed or post-deployment shape of the structure 100. It should be noted, however, that the structure 100 may have any other suitable pre-deployment and post-deployment shapes as needed or desired.

The structure 100 is generally configured to receive and radiate thermal energy. As shown in FIGS. 1A and 1B, the structure 100 includes a number of distinct inline and interconnected thermomechanical regions 102-108. Each of the thermomechanical regions 102-108 represents a portion of the structure 100 that is used to perform at least one specific function. For example, the structure 100 includes one or more heat input regions 102, which are configured to receive thermal energy to be radiated by the structure 100. The structure 100 also includes one or more morphable regions 104, which are configured to change shape in order to change an overall shape of the structure 100 while also being configured to transport thermal energy to or from other regions of the structure 100. The structure 100 further includes one or more adiabatic regions 106, which are configured to provide structural support for the structure 100 while also being configured to transport thermal energy to or from other regions of the structure 100. The term “adiabatic” refers to the characteristic or capability of transferring thermal energy while substantially or completely preventing heat transfer to and from an external environment. In other words, the adiabatic region(s) 106 can transport thermal energy to or from other regions of the structure 100 without leaking the thermal energy into the external environment and without gaining thermal energy from the external environment (at least to a significant extent). In addition, the structure 100 includes one or more heat rejection regions 108, which are configured to receive thermal energy from other regions of the structure 100 and to radiate the thermal energy from the structure 100. In this example, the one or more morphable regions 104 are located between the one or more heat input regions 102 and the one or more heat rejection regions 108. Also, in this example, the one or more adiabatic regions 106 are located between the one or more heat input regions 102 and the one or more heat rejection regions 108.

It should be noted here that one or more of these thermomechanical regions 102-108 may be optional and can be omitted from the structure 100. For example, the one or more adiabatic regions 106 may be omitted if the other thermomechanical regions 102, 104, 108 do not require structural support, reinforcement, or extended heat transport using any adiabatic regions. It should also be noted here that the order or positioning of the thermomechanical regions 102-108 can vary as needed or desired. For instance, an adiabatic region 106 can be positioned between a heat input region 102 and a morphable region 104, or the morphable region 104 can be positioned elsewhere in the structure 100. Also, multiple heat input regions 102, multiple morphable regions 104, multiple adiabatic regions 106, and/or multiple heat rejection regions 108 may be used in the structure 100 in any suitable arrangement.

Each of the thermomechanical regions 102-108 can be formed from any suitable material(s). For example, each morphable region 104 may be formed from one or more shape-memory alloys or other shape-memory material(s). Any suitable shape-memory material or materials may be used here, such as a CuAlNi or NiTi alloy. In some embodiments, multiple (and possibly all) of the thermomechanical regions 102-108 may be formed from one or more shape-memory materials. In these embodiments, the morphable region 104 can implement or assume the roles of one or more of the thermomechanical regions 102, 106, and 108. In other embodiments, only the morphable region 104 is formed from one or more shape-memory materials, and the thermomechanical regions 102, 106, and 108 can be formed from other suitable material(s). For instance, the thermomechanical regions 102, 106, and 108 may be formed from titanium, aluminum, copper, or other metal(s) or material(s) having high thermal conductivity. In particular embodiments, the heat rejection region(s) 108 of the structure 100 may be coated with a suitable material, such as silver fluorinated ethylene propylene (TEFLON), to increase the efficiency of the heat rejection region(s) 108 in radiating thermal energy as emitted radiation. Also, in particular embodiments, the adiabatic region(s) 106 may be coated with a low-emissivity coating or insulator or a multi-layer insulation (MLI) to help reduce or prevent heat loss or heat gain through the adiabatic region(s) 106. For space applications, for instance, an insulator may be painted or otherwise deposited onto the adiabatic region(s) 106, or an MLI blanket can be constructed using multiple layers of aluminized polyimide film (such as KAPTON) with a polyethylene terephthalate mesh (such as DACRON) or other plastic separating each of the layers and attached to a substrate in any number of ways (such as by using rivets, buttons, dual locks, or tape).

In this example, at least one heat source 110 is mounted on the heat input region 102, which allows thermal energy from the heat source 110 to be provided directly to the structure 100. However, this direct mounting of at least one heat source 110 on the structure 100 is not required, and thermal energy from at least one heat source 110 can be provided to the structure 100 in any suitable manner. Each heat source 110 represents any suitable structure configured to generate thermal energy to be removed or rejected using the structure 100. For instance, a heat source 110 can represent electrical circuitry, one or more electronic devices, one or more power supplies, or other component(s) of a satellite, missile, rocket, or other flight vehicle that can generate heat during operation.

In some embodiments, thermal energy from the at least one heat source 110 can be used to cause the morphable region 104 to change shape, which may allow for passive deployment of the structure 100 once placed into operation. In other embodiments, thermal energy from the ambient environment (such as incident or reflected solar radiation) can be used to cause the morphable region 104 to change shape, which may again allow for passive deployment of the structure 100. In still other embodiments, thermal energy from at least one active source (such as a heater or optical energy source) can be used to cause the morphable region 104 to change shape, which may allow for active deployment of the structure 100.

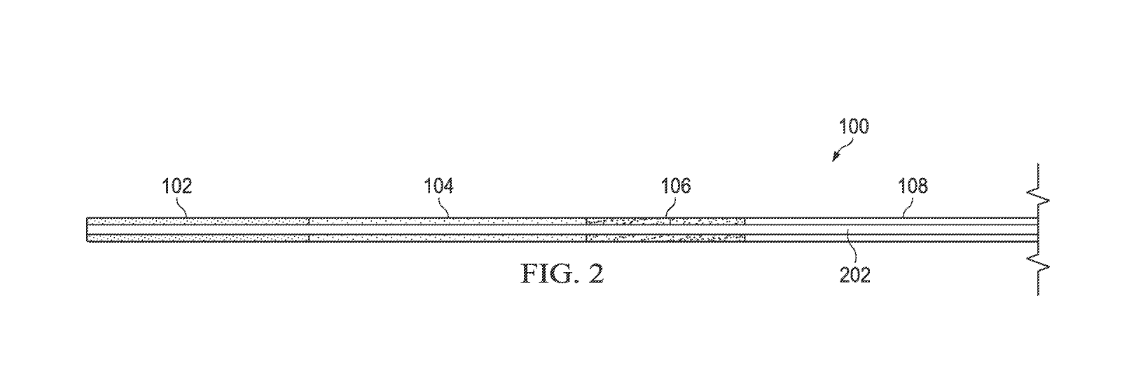

FIG. 2 illustrates an example cross-section of the thermally-enhanced and deployable structure 100 shown in FIGS. 1A and 1B in accordance with this disclosure. As shown in FIG. 2, the structure 100 includes one or more thermal energy transfer devices 202 that are embedded in at least some of the thermomechanical regions 102-108. The one or more thermal energy transfer devices 202 are configured to transfer thermal energy between different ones of the thermomechanical regions 102-108. For example, the thermal energy transfer device 202 may receive thermal energy via the one or more heat input regions 102 and transfer the thermal energy to the one or more heat rejection regions 108 through the other thermomechanical regions 104 and 106. In this way, the thermal energy transfer device 202 helps to transport thermal energy away from the one or more heat sources 110 to the one or more heat rejection regions 108, where the thermal energy can then be radiated away from the structure 100. The thermal energy transfer device 202 thereby helps to compensate for the low thermal conductivity of shape-memory material(s) used in the structure 100.

Each thermal energy transfer device 202 includes any suitable structure configured to transport thermal energy between different thermomechanical regions 102-108 of the structure 100. For example, in some embodiments, each thermal energy transfer device 202 includes one or more oscillating heat pipes. As noted above, each oscillating heat pipe typically represents a serpentine or other tube or passageway that transports heat through phase changes and motion of liquid slugs and vapor bubbles. However, any other or additional suitable thermal energy transfer device(s) 202 may be used in the structure 100. For instance, other phase-change heat transfer devices 202 may be used, where a phase-change heat transfer device represents a device that transfers thermal energy through phase changes in one or more working fluids. Specific examples include other types of heat pipes and vapor chambers. As another example, the thermal energy transfer device(s) 202 may be implemented using one or more highly-thermally conductive materials, such as graphite. As yet another example, the thermal energy transfer device(s) 202 may be implemented using one or more fluid flows, each of which may represent a non-phase-change fluid that transfers thermal energy.

Note that while FIG. 2 shows the thermal energy transfer device 202 extending substantially or completely through all thermomechanical regions 102-108 of the structure 100, this need not be the case. For example, a single thermal energy transfer device 202 may extend completely through one or some thermomechanical regions 102-108 and partially through other thermomechanical regions 102-108. As another example, different thermal energy transfer devices 202 may be used, where each thermal energy transfer device 202 extends partially or completely through one or some (but not all) of the thermomechanical regions 102-108. In general, each of one or more thermal energy transfer devices 202 may support the transport of thermal energy partially or completely through one or more thermomechanical regions 102-108.

In FIG. 1A, the morphable region 104 is shown as having a first state in which the morphable region 104 is generally curved or folded. In FIG. 1B, the morphable region 104 is shown as having a second state in which the morphable region 104 is generally straight. The transition of the structure 100 from the first state shown in FIG. 1A to the second state shown in FIG. 1B occurs in response to heating of the morphable region 104, which causes the shape-memory material(s) of the morphable region 104 to change shape. As noted above, the heating of the morphable region 104 can occur in various ways, such as via passive or active heating. This allows the structure 100 to be deformed so that the structure 100 has a stowed position prior to deployment of a flight vehicle. Once deployed, passive or active heating of the morphable region 104 can occur, causing the structure 100 to deploy and achieve a desired shape more suitable for use in radiating thermal energy.

The first state of the structure 100 can be obtained when the shape-memory material(s) forming at least the morphable region 104 is in an unstrained “martensite phase” and is subsequently deformed to a reversible “strained” condition while remaining in the “martensite phase.” The deformation can be accomplished in any suitable manner, such as by induced out-of-plane mechanical bending deformation up to a maximum material-specific reversible strain. The “martensite phase” can be induced by exposing the shape-memory material(s) of at least the morphable region 104 to a temperature regime below a material-specific “austenite start” transformation temperature. Reversible strain is defined as mechanically-induced strain accommodated by the innate material martensite “detwinning” and elastic deformation mechanisms of the shape-memory material(s) forming at least the morphable region 104.

In the second state of the structure 100, the shape-memory material(s) forming at least the morphable region 104 can return to the “unstrained” condition, which is achieved by transforming the shape-memory material(s) from the “martensite phase” completely to the “austenite phase.” This can be accomplished by subjecting the shape-memory material(s) of at least the morphable region 104 to temperatures above the material-specific “austenite finish” transformation temperature, recovering the induced strain described in the first state. In the second state, the shape of the structure 100 can be specified by the design intent and can be set by standard shape-memory material processing techniques.

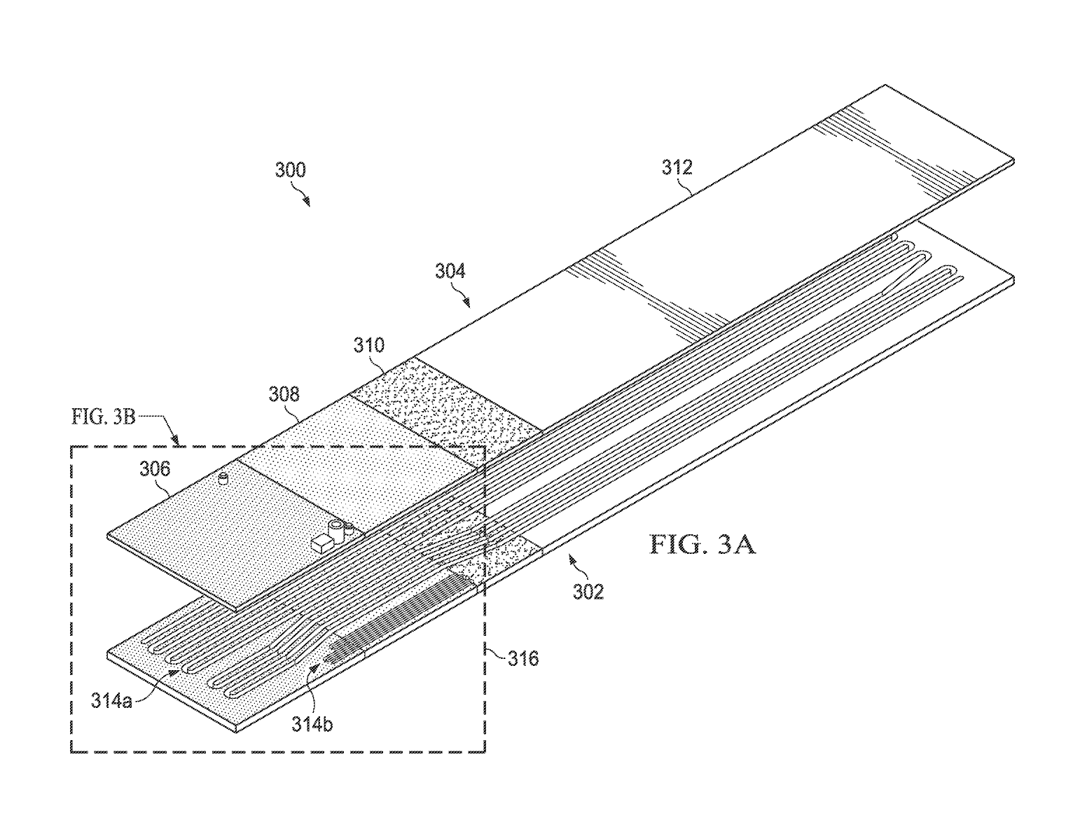

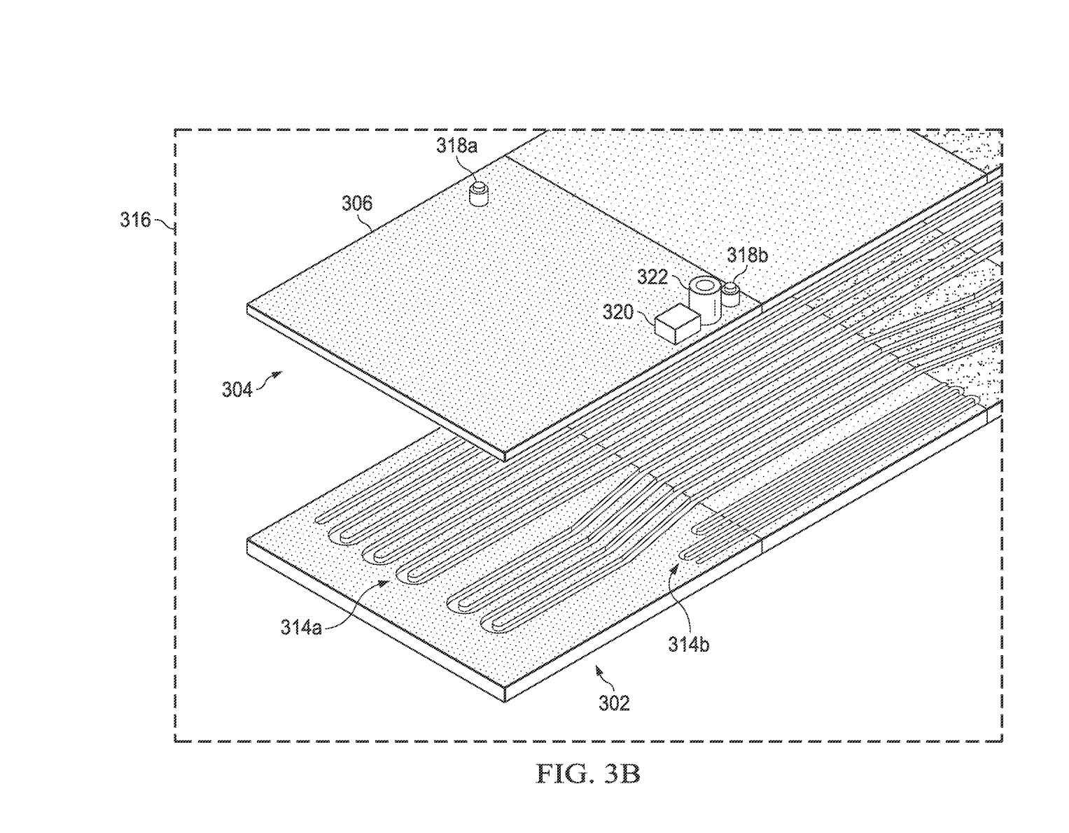

Each of the thermomechanical regions 102-108 and the thermal energy transfer device(s) 202 of the structure 100 can be formed in any suitable manner. For example, one or more thermal energy transfer devices 202 can be formed as channels in a body of the structure 100, and a lid can be placed over and attached to the body in order to form a completed structure 100. This type of implementation is described below with reference to FIGS. 3A and 3B. However, the structure 100 can be formed in any other suitable manner, such as when formed as an integral structure (via injection molding, additive manufacturing, extrusion, or other suitable techniques) or when formed as separate components (via any suitable techniques) that are then connected together. Each of the thermomechanical regions 102-108 may be formed separately and connected together, or some/all of the thermomechanical regions 102-108 may be formed as an integral structure. If separate portions of the structure 100 are formed, those portions may be joined together in any suitable manner, such as via the use of butt joints or other joints that can be formed through laser welding, brazing, friction stir welding, ultrasonic welding, or other suitable techniques.

Although FIGS. 1A and 1B illustrate one example of a thermally-enhanced and deployable structure 100 and FIG. 2 illustrates one example of a cross-section of the thermally-enhanced and deployable structure 100, various changes may be made to FIGS. 1A, 1B, and 2. For example, the shapes of the overall structure 100 shown in FIGS. 1A and 1B are for illustration only and can vary as needed or desired. Also, the relative sizes and shapes of the components of the structure 100 are for illustration only and can vary as needed or desired. FIGS. 3A and 3B illustrate another example thermally-enhanced and deployable structure 300 in accordance with this disclosure. In particular, FIGS. 3A and 3B illustrate a particular implementation of the structure 100 shown in FIGS. 1A, 1B, and 2 described above. The structure 300 here is generally configured to receive and radiate thermal energy. As shown in FIGS. 3A and 3B, the structure 300 includes a body 302 and a lid 304. The lid 304 can be secured to the body 302 in order to form a completed structure 300. Any suitable techniques can be used to secure the lid 304 to the body 302, such as laser welding, brazing, friction stir welding, ultrasonic welding, diffusion bonding, or other techniques. A seal is formed between the body 302 and the lid 304 in order to prevent a working fluid in the structure 300 from leaking during operation.

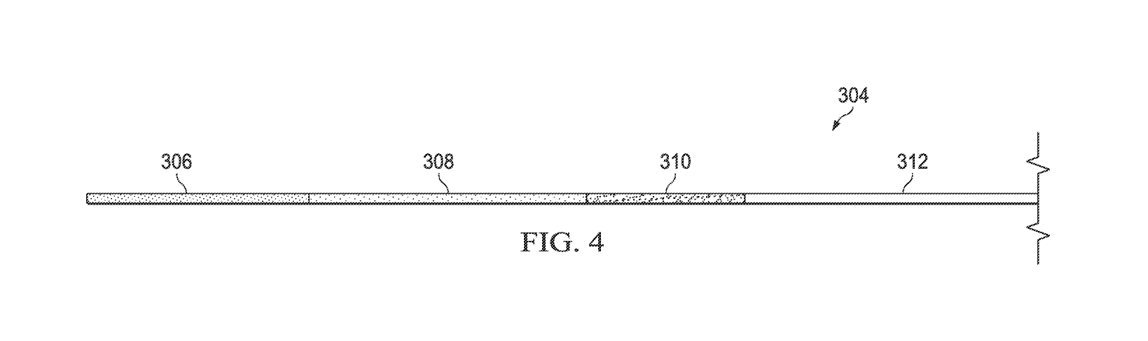

In this example, the body 302 and the lid 304 each includes a number of distinct inline and interconnected thermomechanical regions 306-312. FIG. 4 illustrates an example cross-section of the lid 304 having these thermomechanical regions 306-312. Each of the thermomechanical regions 306-312 represents a portion of the structure 300 that is used to perform at least one specific function. For example, the structure 300 includes one or more heat input regions 306, which are configured to receive thermal energy to be radiated by the structure 300. The structure 300 also includes one or more morphable regions 308, which are configured to change shape in order to change an overall shape of the structure 300 while also being configured to transport thermal energy to or from other regions of the structure 300. The structure 300 further includes one or more adiabatic regions 310, which are configured to provide structural support for the structure 300 while also being configured to transport thermal energy to or from other regions of the structure 300. In addition, the structure 300 includes one or more heat rejection regions 312, which are configured to receive thermal energy from other regions of the structure 300 and to radiate the thermal energy from the structure 300. In this example, the one or more morphable regions 308 are located between the one or more heat input regions 306 and the one or more heat rejection regions 312. Also, in this example, the one or more adiabatic regions 310 are located between the one or more heat input regions 306 and the one or more heat rejection regions 312.

Again, it should be noted here that one or more of these thermomechanical regions 306-312 may be optional and can be omitted from the structure 300. For example, the one or more adiabatic regions 310 may be omitted if the other thermomechanical regions 306, 308, 312 do not require structural support, reinforcement, or extended heat transport using any adiabatic regions. It should also be noted here that the order or positioning of the thermomechanical regions 306-312 can vary as needed or desired. For instance, an adiabatic region 310 can be positioned between a heat input region 306 and a morphable region 308, or the morphable region 308 can be positioned elsewhere in the structure 300. Also, multiple heat input regions 306, multiple morphable regions 308, multiple adiabatic regions 310, and/or multiple heat rejection regions 312 may be used in the structure 300 in any suitable arrangement.

Each of the thermomechanical regions 306-312 shown here can be formed from any suitable material(s). For example, each morphable region 308 may be formed from one or more shape-memory alloys or other shape-memory material(s). Any suitable shape-memory material or materials may be used here, such as a CuAlNi or NiTi alloy. In some embodiments, multiple (and possibly all) of the thermomechanical regions 306-312 may be formed from one or more shape-memory materials. In these embodiments, the morphable region 308 can implement or assume the roles of one or more of the thermomechanical regions 306, 310, and 312. In other embodiments, only the morphable region 308 is formed from one or more shape-memory materials, and the thermomechanical regions 306, 310, and 312 can be formed from other suitable material(s). For instance, the thermomechanical regions 306, 310, and 312 may be formed from titanium, aluminum, copper, or other metal(s) or material(s) having high thermal conductivity. In particular embodiments, at least the heat rejection region(s) 312 of the structure 300 may be coated with a suitable material, such as silver fluorinated ethylene propylene (TEFLON), to increase the efficiency of the heat rejection region(s) 312 in radiating thermal energy as emitted radiation. Also, in particular embodiments, the adiabatic region(s) 310 may be coated with a low-emissivity coating or insulator or an MLI to help reduce or prevent heat loss or heat gain through the adiabatic region(s) 310. For space applications, for instance, an insulator may be painted or otherwise deposited onto the adiabatic region(s) 106, or an MLI blanket can be constructed using multiple layers of aluminized polyimide film (such as KAPTON) with a polyethylene terephthalate mesh (such as DACRON) or other plastic separating each of the layers and attached to a substrate in any number of ways (such as by using rivets, buttons, dual locks, or tape).

Each of the body 302 and the lid 304 can have any suitable size, shape, and dimensions. For example, the lid 304 may have the same shape as the body 302 and have an equal or smaller thickness compared to a thickness of the body 302 (although this need not be the case). Also, the structure 300 may have any suitable shapes in its pre-deployment and post-deployment states, such as the shapes shown in FIGS. 1A and 1B.

As shown here, the structure 300 also includes one or more thermal energy transfer devices. In this example, an oscillating heat pipe core is used to implement the thermal energy transfer device(s), where the core includes one or more oscillating heat pipe circuits 314a-314b. Each oscillating heat pipe circuit 314a-314b represents a passageway through which liquid and vapor can move. In some embodiments, a working fluid in the passageway can exist in liquid form until adequately heated, such as by thermal energy received through one or more heat input regions 306. Fluid in vapor form in the passageway can later re-enter the liquid form when the vapor is cooled, such as when thermal energy is removed from the vapor by one or more heat rejection regions 312. Thus, thermal energy can be transported through the structure 300 using phase changes and motion of liquid slugs and vapor bubbles in each oscillating heat pipe circuit 314a-314b.

In this particular example, there are two oscillating heat pipe circuits 314a-314b. A portion 316 of the structure 300 in FIG. 3A is shown in an enlarged view in FIG. 3B. As can be seen here, the oscillating heat pipe circuit 314a generally includes one or more larger fluid passageways formed using wider turns, while the oscillating heat pipe circuit 314b generally includes one or more smaller fluid passageways formed using smaller turns. Also, the oscillating heat pipe circuit 314a here extends across substantially all of the thermomechanical regions 306-312 of the body 302, while the oscillating heat pipe circuit 314b here extends across the thermomechanical region 308 and partially into the thermomechanical regions 306 and 310. Note, however, that these two implementations of the oscillating heat pipe circuits 314a-314b are for illustration only.

Each oscillating heat pipe circuit 314a-314b has an associated charging port 318a-318b, which allows fluid to be injected into that oscillating heat pipe circuit 314a-314b after the lid 304 has been secured to the body 302. In some embodiments, each charging port 318a-318b is welded or otherwise secured to the structure 300 and can be closed or otherwise sealed after fluid is injected into the associated oscillating heat pipe circuit 314a-314b. Alternatively, if it is possible to include fluid in the oscillating heat pipe circuits 314a-314b during fabrication of the structure 300, the charging ports 318a-318b may potentially be omitted here.

In the specific arrangement shown here, the oscillating heat pipe circuit 314a can be used to transport thermal energy to be rejected through the structure 300 from one or more heat input regions 306 to one or more heat rejection regions 312. The oscillating heat pipe circuit 314b can be used to transport thermal energy from a heater 320 or a feed port 322 at least partially through the morphable region(s) 308. The heater 320 represents a resistive heater or other circuit or device configured to generate thermal energy. The feed port 322 represents a fiber optic port or other port configured to receive thermal energy from an external source. In either case, the thermal energy from the heater 320 or feed port 322 is provided into one or more morphable regions 308, allowing the morphable region(s) 308 to change shape. This supports active deployment of the structure 300. If the morphable regions 308 are to be triggered using incident or reflected radiation, focused radiation can be provided to the feed port 322. The radiation received at the feed port 322 can be provided by any suitable source(s), such as one or more lasers, light emitting diodes (LEDs), or solar collectors. While the heater 320 and feed port 322 are shown here as residing on a heat input region 306 of the lid 304, each of the heater 320 and the feed port 322 may be located at any other suitable position on the lid 304 or the body 302. Also, the structure 300 does not need to include both the heater 320 and the feed port 322.

Note that the use of active heating of the morphable region(s) 308 is not required and that the morphable region(s) 308 can change shape in any other suitable manner. For instance, the morphable region(s) 308 can change shape based on thermal energy being transported through the oscillating heat pipe circuit 314a. Thus, the heater 320 and the feed port 322 (along with the oscillating heat pipe circuit 314b) may be omitted here. Also, even when a heater 320 and/or a feed port 322 is used, the oscillating heat pipe circuit 314a may be used to transport thermal energy, so the oscillating heat pipe circuit 314b may be omitted. In general, one or more morphable regions 308 of the structure 300 may change shape based on any suitable passive or active heating of the morphable region(s) 308. Moreover, the structure 300 may include any suitable number and arrangement of oscillating heat pipe circuit(s), and the oscillating heat pipe circuit(s) may be used to transport thermal energy in any suitable manner between any desired locations of the structure 300. Thus, the structure 300 can include one or more oscillating heat pipe circuits of any suitable sizes, densities, and heat transfer capabilities.

Also note that there is no requirement for both the body 302 and the lid 304 to include all four types of thermomechanical regions 306-312. In some embodiments, for example, the lid 304 may include only the morphable region 308. In those embodiments, the morphable regions 308 of the body 302 and the lid 304 may have a combined thickness that matches or approximately matches the thickness of other regions 306, 310, 312 of the body 302 (although this need not be the case).

Each of the body 302, the lid 304, and the thermomechanical regions 306-312 can be formed in any suitable manner. For example, each of the thermomechanical regions 306-312 of the body 302 and/or lid 304 may be formed separately and connected together, or some/all of the thermomechanical regions 306-312 of the body 302 and/or lid 304 may be formed as an integral structure. If separate portions of the body 302 and/or lid 304 are formed, those portions may be joined together in any suitable manner, such as via the use of butt joints or other joints that can be formed through laser welding, brazing, friction stir welding, ultrasonic welding, or other suitable techniques. One or more oscillating heat pipe circuits 314a-314b can also be formed in any suitable manner, such as by using photochemical machining, computer numerical control (CNC) milling, additive manufacturing, or other suitable techniques.

Once again, the structure 300 may be placed into a first state prior to deployment and then obtain a second state after deployment. The first state of the structure 300 can be obtained when the shape-memory material(s) forming at least the morphable regions 308 is in an unstrained “martensite phase” and is subsequently deformed to a reversible “strained” condition while remaining in the “martensite phase.” The deformation can be accomplished in any suitable manner, such as by induced out-of-plane mechanical bending deformation up to a maximum material-specific reversible strain. The “martensite phase” can be induced by exposing the shape-memory material(s) of at least the morphable regions 308 to a temperature regime below a material-specific “austenite start” transformation temperature. This state can be induced to the body 302 and lid 304 separately or to the structure 300 after full integration of the lid 304 and the body 302.

In the second state of the structure 300, the shape-memory material(s) forming at least the morphable regions 308 can return to the “unstrained” condition, which is achieved by transforming the shape-memory material(s) from the “martensite phase” completely to the “austenite phase.” This can be accomplished by subjecting the shape-memory material(s) of at least the morphable regions 308 to temperatures above the material-specific “austenite finish” transformation temperature, recovering the induced strain described in the first state. In the second state, the shape of the structure 300 can be specified by the design intent and can be set by standard shape-memory material processing techniques.

Although FIGS. 3A and 3B illustrate another example of a thermally-enhanced and deployable structure 300 and FIG. 4 illustrates one example of a cross-section of a lid 304 of the thermally-enhanced and deployable structure 300, various changes may be made to FIGS. 3A, 3B, and 4. For example, the shapes of the overall structure 300 in its various states can vary as needed or desired. Also, the relative sizes and shapes of the components of the structure 300 are for illustration only and can vary as needed or desired. In addition, while the oscillating heat pipe circuits 314a-314b are shown here as being formed completely within the body 302, part or all of one or more oscillating heat pipe circuits 314a-314b may be formed in the lid 304. For instance, one or more oscillating heat pipe circuits 314a-314b may be formed in the body 302 and the lid 304 symmetrically across a bond line interface between the body 302 and the lid 304, where the bond line interface is aligned with a neutral axis of the structure 300.

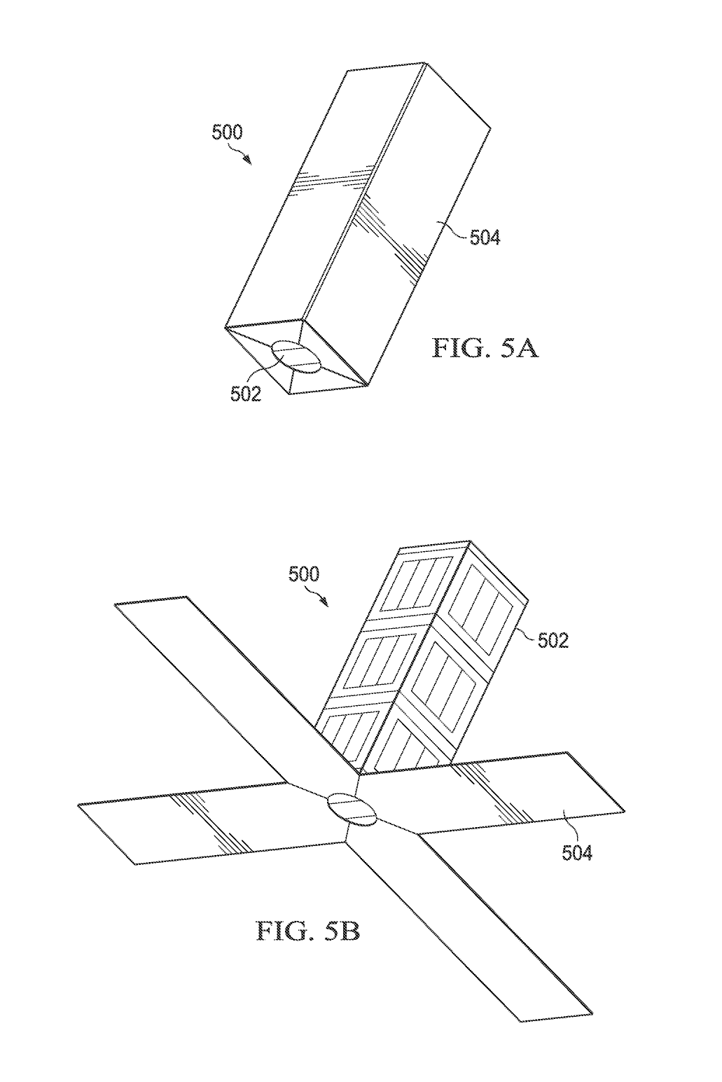

FIGS. 5A and 5B illustrate a first example use of thermally-enhanced and deployable structures in accordance with this disclosure. In this example, a system 500 includes a satellite 502 and one or more deployable radiators 504. In this particular example, the satellite 502 represents a three-unit cube satellite, although any other suitable satellite or other space vehicle may be used here. Also, in this particular example, the system 500 includes four deployable radiators 504, although other numbers of deployable radiators 504 (including a single radiator) may be used here.

In a first state shown in FIG. 5A, the deployable radiators 504 have a first shape and generally conform to an outer surface of the satellite 502. This state may be referred to as a stowed configuration since it is typically used prior to deployment of the satellite 502 (as it reduces the overall size of the satellite 502). In a second state shown in FIG. 5B, the deployable radiators 504 have a second shape and generally extend away from the satellite 502. This state may be referred to as a deployed configuration since it is typically used after deployment of the satellite 502 (as it increases the total surface area of the radiators 504 pointing in a thermally advantageous direction). Once the radiators 504 are deployed, the radiators 504 can be pointed in one or more suitable directions (such as into deep space), enabling heat rejection for radiating thermal energy generated by the satellite 502.

Each of the deployable radiators 504 here can be implemented in any suitable manner. For example, each deployable radiator 504 may be implemented as or include the structure 100 shown in FIGS. 1A, 1B, and 2 or the structure 300 shown in FIGS. 3A, 3B, and 4. Thus, each deployable radiator 504 may include multiple thermomechanical regions 102-108 and one or more integrated thermal energy transfer devices 202, or each deployable radiator 504 may include a body 302 and lid 304 having multiple thermomechanical regions 306-312 and one or more integrated oscillating heat pipe circuits 314a-314b. Here, the morphable regions 104, 308 of the deployable radiators 504 act as hinges for the deployable radiators 504, allowing the deployable radiators 504 to be bent around the outer surface of the satellite 502. However, since these hinges are formed using the morphable regions 104, 308, the hinges are inline and continuous with the remainder of the deployable radiators 504 and allow effective transport of thermal energy through the hinges.

In some embodiments, the radiators 504 can be deployed passively, such as based on thermal energy generated by the satellite 502 after deployment. This thermal energy can be transported through the radiators 504, such as by one or more thermal energy transfer devices 202 or oscillating heat pipe circuits 314a. In other words, the deployment of the radiators 504 can be based on the waste heat being rejected using the radiators 504. This allows the radiators 504 to be passively activated using waste heat from one or more electrical components, power supplies, or other components of the satellite 502. As long as there is thermally-conductive communication between one or more heat sources (such as one or more sources 110) and the heat input regions 102, 306 of the deployable radiators 504, waste heat can be transferred via the thermal energy transfer devices 202 or oscillating heat pipe circuits 314a to the morphable regions 104, 308. The waste heat can therefore supply the necessary impulse to transform the morphable regions 104, 308 from the first state in FIG. 5A to the second state in FIG. 5B.

In other embodiments, the radiators 504 can be deployed actively, such as based on thermal energy obtained or generated by the satellite 502 specifically for extending the radiators 504 after deployment. Thus, for example, a heater 320 can actively generate thermal energy that causes the radiators 504 to extend, or incident or reflected electromagnetic radiation (possibly focused) can be received through the feed port 322 and used to actively generate thermal energy that causes the radiators 504 to extend. If used, electromagnetic radiation can be obtained from any suitable source(s), such as one or more lasers, LEDs, or solar collectors. Once the radiators 504 have been extended, waste heat from one or more electrical components, power supplies, or other components of the satellite 502 can be rejected.

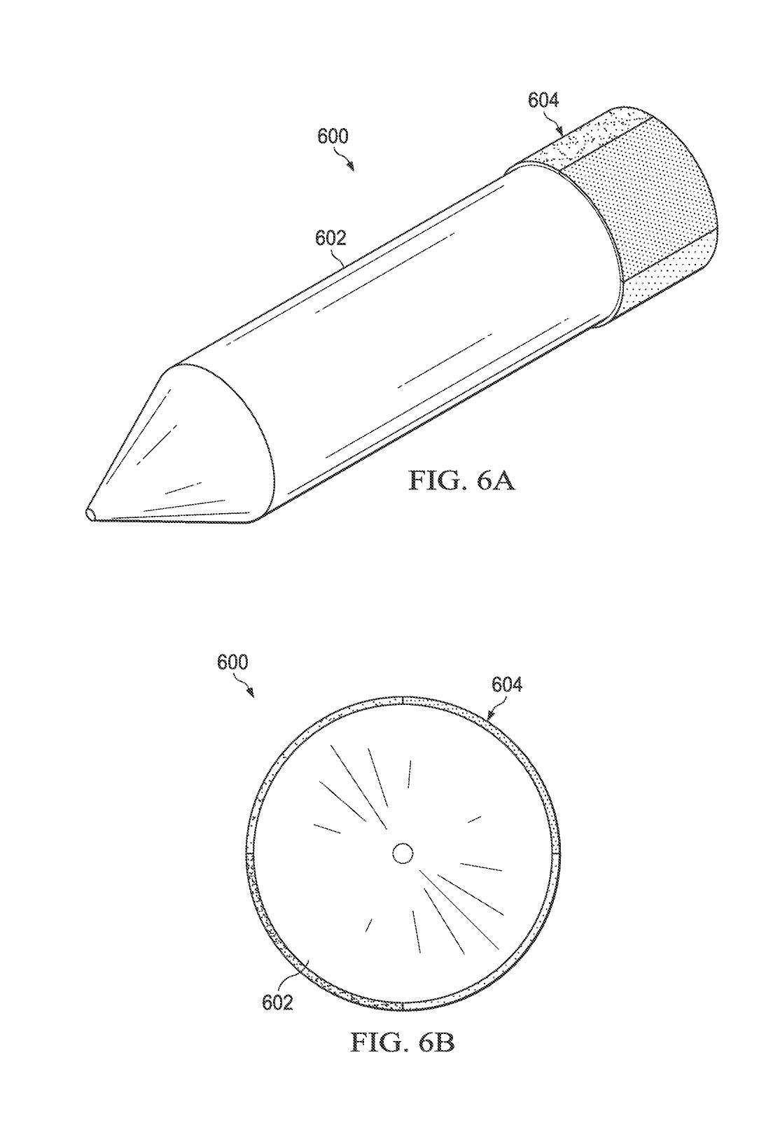

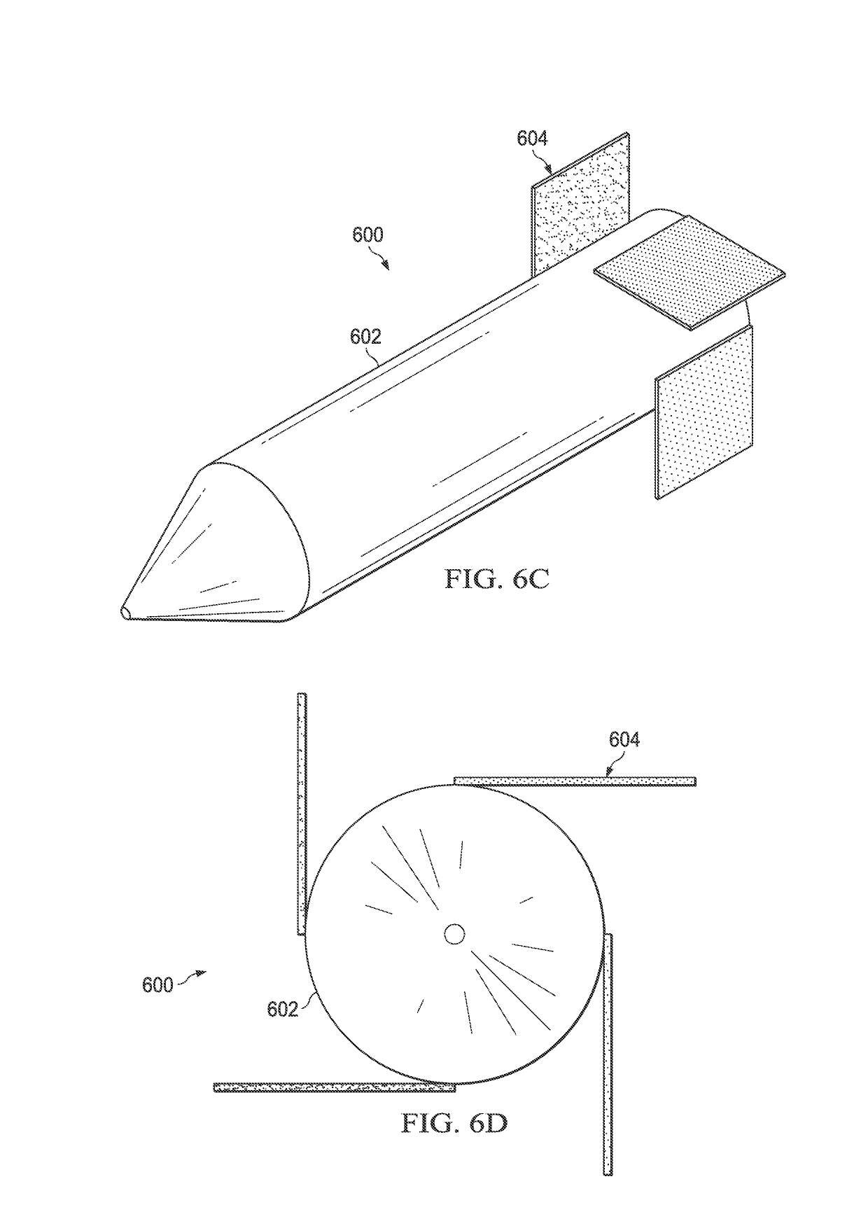

FIGS. 6A through 6D illustrate a second example use of thermally-enhanced and deployable structures in accordance with this disclosure. In this example, a system 600 includes a platform 602 and one or more deployable radiators 604. In this particular example, the platform 602 represents a flight vehicle such as a rocket or missile, although any other suitable flight vehicle may be used here. Also, in this particular example, the system 600 includes four deployable radiators 604, although other numbers of deployable radiators 604 (including a single radiator) may be used.

In a first state shown in FIGS. 6A and 6B, the deployable radiators 604 have a first shape and generally conform to an outer surface of the platform 602. This state may be referred to as a stowed configuration since it is typically used prior to launch of the platform 602. In a second state shown in FIGS. 6C and 6D, the deployable radiators 604 have a second shape and generally extend away from the platform 602. This state may be referred to as a deployed configuration since it is typically used after launch of the platform 602.

Each of the deployable radiators 604 here can be implemented in any suitable manner. For example, each deployable radiator 604 may be implemented as or include the structure 100 shown in FIGS. 1A, 1B, and 2 or the structure 300 shown in FIGS. 3A, 3B, and 4. Thus, each deployable radiator 604 may include multiple thermomechanical regions 102-108 and one or more integrated thermal energy transfer devices 202, or each deployable radiator 604 may include a body 302 and lid 304 having multiple thermomechanical regions 306-312 and one or more integrated oscillating heat pipe circuits 314a-314b. Here, the morphable regions 104, 308 of the deployable radiators 604 act as hinges for the deployable radiators 604, allowing the deployable radiators 604 to be bent around the outer surface of the platform 602. However, since these hinges are formed using the morphable regions 104, 308, the hinges are inline and continuous with the remainder of the deployable radiators 604 and allow effective transport of thermal energy through the hinges.

The radiators 604 can be deployed passively or actively depending on the embodiment. For example, waste heat, aeronautical heating, solar loading, ambient temperature, or other thermal energy can be used to extend the radiators 604 after launch of the platform 602. Once deployed, the radiators 604 can be used to reject waste heat from one or more electrical components, power supplies, or other components of the platform 602. Each of the deployable radiators 604 in this example can actually serve multiple functions. For example, the deployable radiators 604 can be used to reject waste heat from the platform 602. The deployable radiators 604 can also be used as one or more aerodynamic control surfaces (such as one or more stabilizer fins), which provide for aerodynamic control or stabilization of the platform 602 during flight.

Note that in this example, each radiator 604 is curved along substantially its entire length in the stowed configuration and is straight along substantially its entire length in the deployed configuration. To accommodate this change in shape, most or all of the thermomechanical regions 102-108, 306-312 in each radiator 604 may be formed using one or more shape-memory materials. In this type of design, each radiator 604 may be formed using one or more morphable regions 104, 308 that include or implement the heat input, adiabatic, and heat rejection regions of the radiator 604.

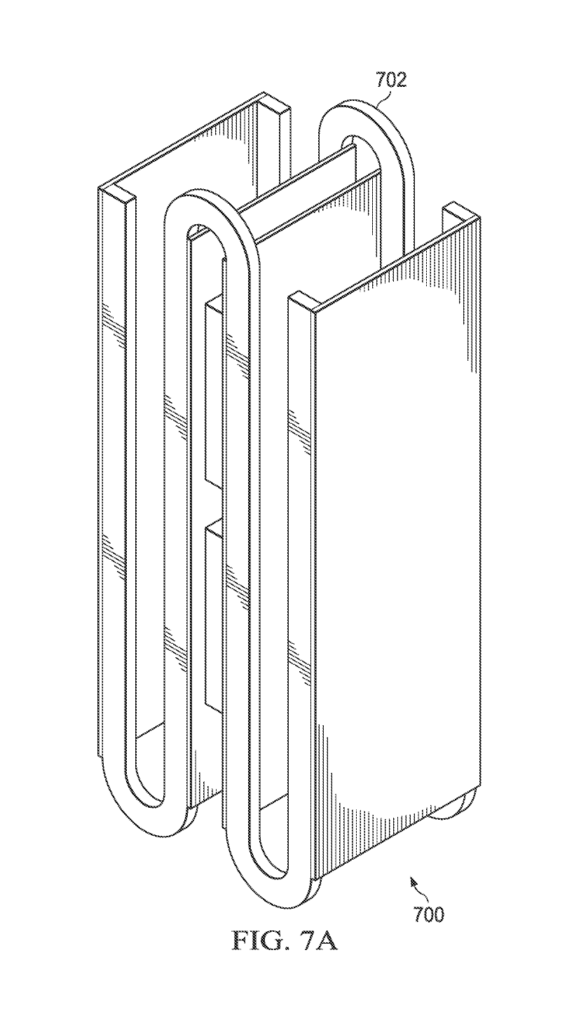

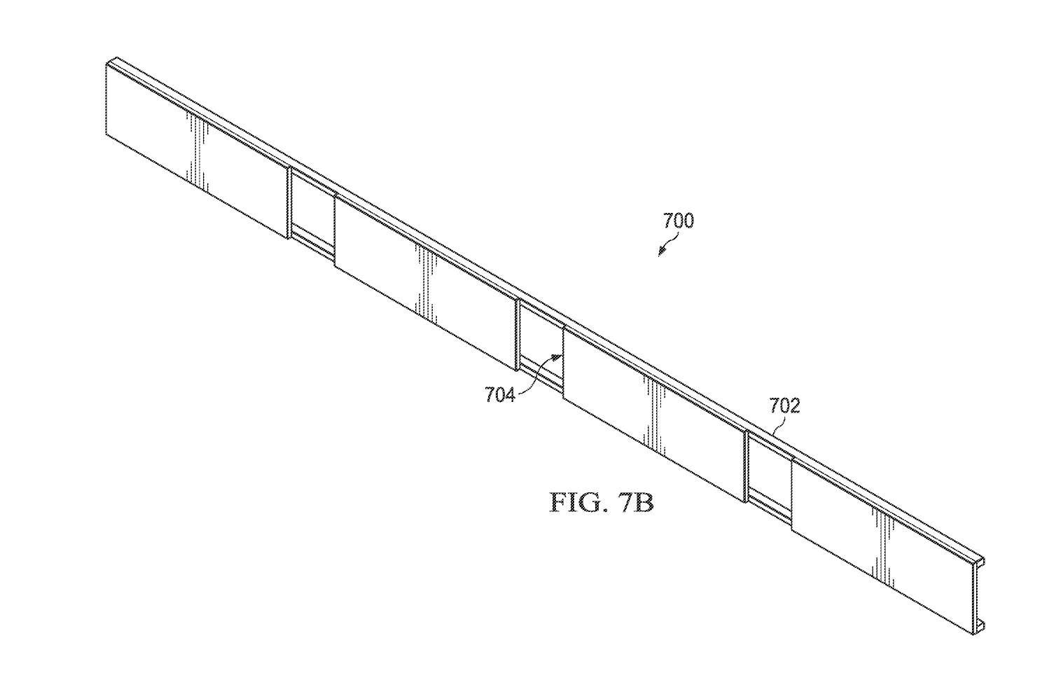

FIGS. 7A and 7B illustrate a third example use of thermally-enhanced and deployable structures in accordance with this disclosure. In this example, a system 700 represents a shape-morphable satellite having a primary support structure 702 carrying various satellite components 704. The satellite components 704 may represent solar panels or other components supporting desired functionality of the system 700. In this particular example, the primary support structure 702 generally represents a folded or elongated rectangular structure, although any other suitable shape can be used here. Also, in this particular example, there are four generally-rectangular satellite components 704, although any number of satellite components 704 (including a single component) each having any suitable shape can be used here.

In a first state shown in FIG. 7A, the primary support structure 702 is folded and has a first shape. This state may be referred to as a stowed configuration since it is typically used prior to deployment of the system 700. In a second state shown in FIG. 7B, the primary support structure 702 is unfolded and has a second shape (which is substantially straight in this example). This state may be referred to as a deployed configuration since it is typically used after deployment of the system 700.

The primary support structure 702 here can be implemented in any suitable manner. For example, the folded portions of the primary support structure 702 in FIG. 7A may be implemented as or include morphable regions 104, 308, while other portions of the primary support structure 702 may be implemented as or include other regions 102, 306, 106, 310, 108, 312. The morphable regions 104, 308 of the primary support structure 702 may therefore represent the curved portions of the primary support structure 702 in FIG. 7A. The morphable regions 104, 308 can straighten as shown in FIG. 7B after deployment of the system 700. Once deployed, the entire primary support structure 702 can be used as one or more thermal radiators.

The primary support structure 702 can be deployed passively or actively depending on the embodiment. For example, the primary support structure 702 may be deployed using waste heat from the satellite components 704 or active heat generated as described above. Heat input regions 102, 306 of the primary support structure 702 may also be coated with a selective heat-absorptive material (or equivalent material) and oriented to maximize incident radiation occurring by albedo or directly from a celestial body such as the sun. The absorption of solar radiation can provide the necessary impulse to transform the morphable regions 104, 308 of the primary support structure 702 from the first state shown in FIG. 7A to the second state shown in FIG. 7B. Once deployed, the primary support structure 702 can be used to reject waste heat from one or more electrical components, power supplies, or other components of the system 700, which may be included in one or more of the satellite components 704.

Although FIGS. 5A through 7B illustrate example uses of thermally-enhanced and deployable structures, various changes may be made to FIGS. 5A through 7B. For example, while FIGS. 5A through 7B illustrate various ways in which the structures 100, 300 described above can be used or implemented, the structures 100, 300 can be used in any other suitable manner. Also, there are various ways in which the structures 100, 300 described above can be passively or actively triggered to change shape, including the use of thermal energy originating from one or more components internal to a system or from an external environment, the use of incident or reflected solar radiation, and the use of actively-generated thermal energy. In general, any suitable mechanisms or techniques can be used to trigger a shape change in one or more instances of the structures 100, 300.

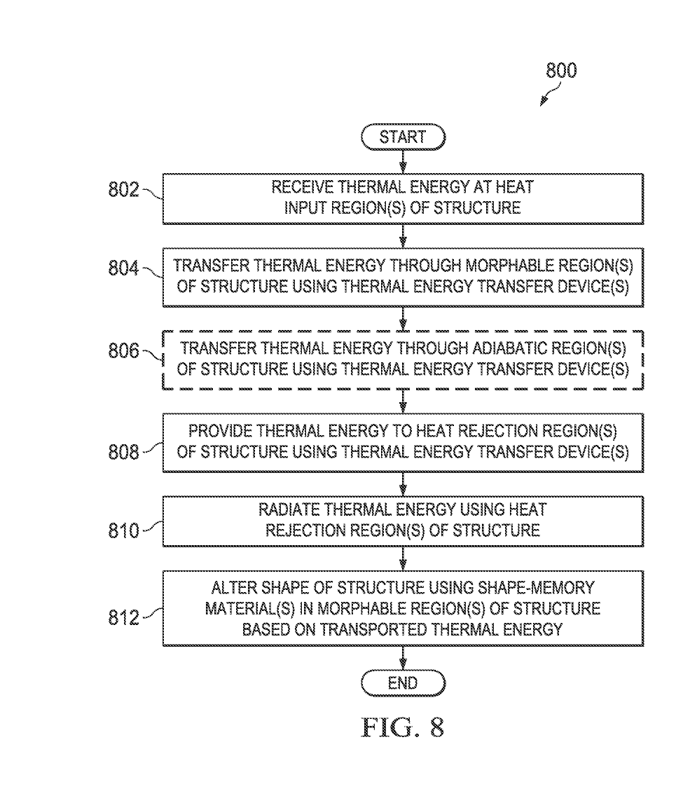

FIG. 8 illustrates a first example method 800 for using a thermally-enhanced and deployable structure in accordance with this disclosure. For ease of explanation, the method 800 is described as involving the use of the structure 100 or 300 described above. However, the method 800 can involve the use of any suitable structure designed in accordance with this disclosure.

As shown in FIG. 8, thermal energy is received at one or more heat input regions of a structure at step 802. This may include, for example, thermal energy from one or more heat sources 110 being received at the heat input region(s) 102, 306 of the structure 100, 300. The thermal energy is transferred through one or more morphable regions of the structure at step 804 and optionally through one or more adiabatic regions of the structure at step 806 using at least one thermal energy transfer device. This may include, for example, one or more thermal energy transfer devices 202 or one or more oscillating heat pipe circuits 314a transferring the received thermal energy through the morphable region(s) 104, 308 and optionally through the adiabatic region(s) 106, 310 of the structure 100, 300. The use of the adiabatic region(s) 106, 310 is optional since the structure 100, 300 may not require structural support, reinforcement, or extended heat transport using any adiabatic regions.

The thermal energy is provided to one or more heat rejection regions of the structure using the at least one thermal energy transfer device at step 808. This may include, for example, the one or more thermal energy transfer devices 202 or one or more oscillating heat pipe circuits 314a transferring the thermal energy to the heat rejection region(s) 108, 312 of the structure 100, 300. The thermal energy is radiated from the structure using the one or more heat rejection regions of the structure at step 810. This may include, for example, the heat rejection region(s) 108, 312 of the structure 100, 300 emitting the thermal energy into the surrounding environment.

A shape of the structure is altered using one or more shape-memory materials of the one or more morphable regions of the structure based on the transported thermal energy at step 812. This may include, for example, the one or more shape-memory materials of the morphable region(s) 104, 308 being heated by the thermal energy transported through the one or more thermal energy transfer devices 202 or one or more oscillating heat pipe circuits 314a. This may also include the one or more shape-memory materials of the morphable region(s) 104, 308 changing shape by returning to a programmed shape. In this way, the morphable region(s) 104, 308 can be passively triggered.

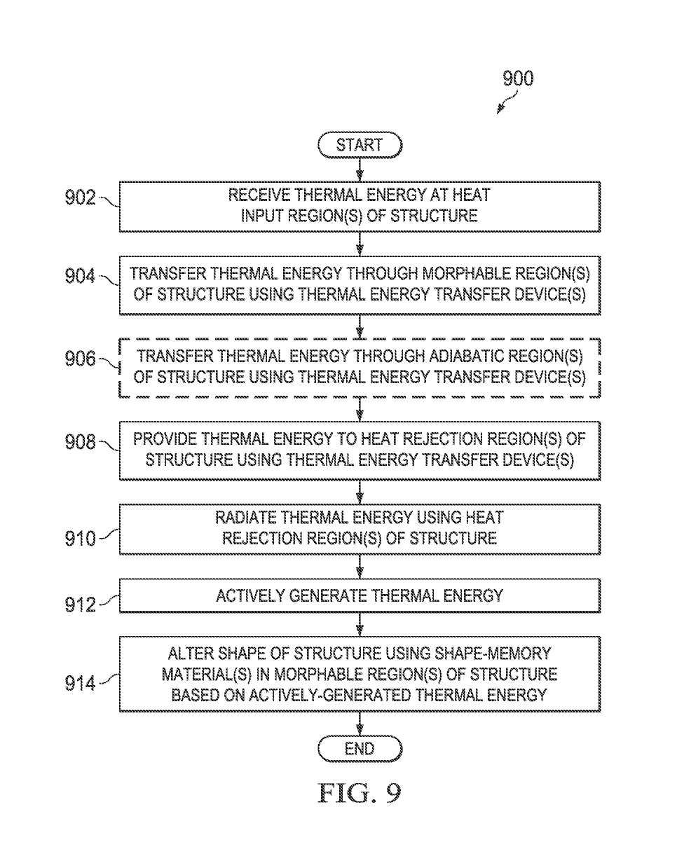

FIG. 9 illustrates a second example method 900 for using a thermally-enhanced and deployable structure in accordance with this disclosure. For ease of explanation, the method 900 is described as involving the use of the structure 100 or 300 described above. However, the method 900 can involve the use of any suitable structure designed in accordance with this disclosure.

As shown in FIG. 9, thermal energy is received at one or more heat input regions of a structure at step 902, and the thermal energy is transferred through one or more morphable regions of the structure at step 904 and optionally through one or more adiabatic regions of the structure at step 906 using at least one thermal energy transfer device. The thermal energy is provided to one or more heat rejection regions of the structure using the at least one thermal energy transfer device at step 908. The thermal energy is radiated from the structure using the one or more heat rejection regions of the structure at step 910. These steps 902-910 may occur in the same or similar manner as steps 802-810 in FIG. 8.

Thermal energy is actively generated at step 912, and a shape of the structure is altered using one or more shape-memory materials of the one or more morphable regions of the structure based on the actively-generated thermal energy at step 914. This may include, for example, one or more heaters 320 being used to generate thermal energy that is provided to the morphable region(s) 104, 308 via at least one oscillating heat pipe circuit 314b or other thermal energy transfer device 202. This may also or alternatively include one or more feed port 322 being used to receive energy that is provided to the morphable region(s) 104, 308 via at least one oscillating heat pipe circuit 314b or other thermal energy transfer device 202. This may further include the one or more shape-memory materials of the morphable region(s) 104, 308 changing shape by returning to a programmed shape. In this way, the morphable region(s) 104, 308 can be actively triggered.

Although FIGS. 8 and 9 illustrate examples of methods 800, 900 for using a thermally-enhanced and deployable structure, various changes may be made to FIGS. 8 and 9. For example, while shown as a series of steps, various steps in each figure can overlap, occur in parallel, occur in a different order, or occur any number of times. As a particular example, the shape of a thermally-enhanced and deployable structure may be altered before, during, or after thermal energy is radiated from the structure. Also, as noted above, there are various ways in which a thermally-enhanced and deployable structure can be passively or actively deployed, and any of these approaches can be used in FIGS. 8 and 9. In addition, the steps shown in FIGS. 8 and 9 can occur with any desired number of thermally-enhanced and deployable structures (either sequentially or concurrently).

Note that while this disclosure has often described deployable radiators and other structures being configured or used to “radiate” thermal energy, there are various physical mechanisms that allow thermal energy to be removed from the deployable radiators and other structures. These physical mechanisms include radiation, convection, and conduction of thermal energy. Depending on the design of a deployable radiator or other structure and depending on the external environment around the structure, thermal energy may be removed from the structure via radiation, convection, or conduction (or any suitable combination thereof). The term “reject” and its derivatives encompass all of these physical mechanisms for removing thermal energy from a structure. Thus, a heat rejection region of a structure can be used to remove thermal energy from the structure via at least one of radiation, convection, and conduction.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in this patent document should not be read as implying that any particular element, step, or function is an essential or critical element that must be included in the claim scope. Also, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a structure configured to receive thermal energy and to reject the thermal energy into an external environment;
wherein the structure comprises (i) multiple inline and interconnected thermomechanical regions and (ii) one or more thermal energy transfer devices embedded in at least some of the thermomechanical regions;
wherein the one or more thermal energy transfer devices are configured to transfer the thermal energy between different ones of the thermomechanical regions; and
wherein at least one of the thermomechanical regions comprises one or more shape-memory materials configured to cause a shape of the structure to change.

2. The apparatus of claim 1, wherein the thermomechanical regions comprise:
one or more heat input regions configured to receive the thermal energy;
one or more heat rejection regions configured to reject the thermal energy into the external environment; and
one or more morphable regions comprising the one or more shape-memory materials and configured to change shape.

3. The apparatus of claim 2, wherein the thermomechanical regions further comprise:
one or more adiabatic regions configured to provide structural support or reinforcement while at least substantially preventing heat transfer to and from an external environment.

4. The apparatus of claim 1, wherein:
the structure comprises a lid and a body, different portions of at least one of the lid and the body forming the thermomechanical regions; and
channels in the structure form the one or more thermal energy transfer devices.

5. The apparatus of claim 1, wherein the one or more thermal energy transfer devices are configured to receive thermal energy resulting from heat originating from one or more components internal to a system or from an external environment.

6. The apparatus of claim 1, wherein the one or more thermal energy transfer devices are configured to receive thermal energy from incident solar radiation or reflected solar radiation.

7. The apparatus of claim 1, wherein:
the apparatus further comprises at least one heater configured to actively generate thermal energy;
the one or more thermal energy transfer devices are configured to receive the actively-generated thermal energy; and
the one or more shape-memory materials are configured to cause the shape of the structure to change based on the actively-generated thermal energy.

8. A system comprising:
a flight vehicle; and
one or more deployable radiators, wherein:
each deployable radiator comprises a structure configured to receive thermal energy and to reject the thermal energy into an external environment;
the structure comprises (i) multiple inline and interconnected thermomechanical regions and (ii) one or more thermal energy transfer devices embedded in at least some of the thermomechanical regions;
the one or more thermal energy transfer devices are configured to transfer the thermal energy between different ones of the thermomechanical regions; and
at least one of the thermomechanical regions comprises one or more shape-memory materials configured to cause a shape of the structure to change.

9. The system of claim 8, wherein, for each deployable radiator, the thermomechanical regions comprise:
one or more heat input regions configured to receive the thermal energy;
one or more heat rejection regions configured to reject the thermal energy into the external environment; and
one or more morphable regions comprising the one or more shape-memory materials and configured to change shape.

10. The system of claim 9, wherein, for each deployable radiator, the thermomechanical regions further comprise:
one or more adiabatic regions configured to provide structural support or reinforcement while at least substantially preventing heat transfer to and from an external environment.

11. The system of claim 8, wherein, for each deployable radiator:
the structure comprises a lid and a body, different portions of at least one of the lid and the body forming the thermomechanical regions; and
channels in the structure form the one or more thermal energy transfer devices.

12. The system of claim 8, wherein, for each deployable radiator, the one or more thermal energy transfer devices are configured to receive thermal energy resulting from heat originating from one or more components internal to the system or from an external environment.

13. The system of claim 8, wherein, for each deployable radiator, the one or more thermal energy transfer devices are configured to receive thermal energy from incident solar radiation or reflected solar radiation.

14. The system of claim 8, wherein:
the system further comprises at least one heater configured to actively generate thermal energy;
for each deployable radiator, the one or more thermal energy transfer devices are configured to receive the actively-generated thermal energy; and
for each deployable radiator, the one or more shape-memory materials are configured to cause the shape of the structure to change based on the actively-generated thermal energy.

15. The system of claim 8, wherein the flight vehicle comprises one of: a satellite, a shape-morphable satellite, a rocket, and a missile.

16. The system of claim 8, wherein each deployable radiator is configured to reject thermal energy and to function as an aerodynamic control surface after the deployable radiator changes shape.

17. A method comprising:
receiving thermal energy at a structure, the structure comprising (i) multiple inline and interconnected thermomechanical regions and (ii) one or more thermal energy transfer devices embedded in at least some of the thermomechanical regions;
transferring the thermal energy between different ones of the thermomechanical regions using the one or more thermal energy transfer devices; and
rejecting the thermal energy from the structure into an external environment;
wherein at least one of the thermomechanical regions comprises one or more shape-memory materials configured to cause a shape of the structure to change.

18. The method of claim 17, wherein the thermomechanical regions comprise:
one or more heat input regions configured to receive the thermal energy;
one or more heat rejection regions configured to reject the thermal energy into the external environment; and
one or more morphable regions comprising the one or more shape-memory materials and configured to change shape.

19. The method of claim 18, wherein the thermomechanical regions further comprise:
one or more adiabatic regions configured to provide structural support or reinforcement while at least substantially preventing heat transfer to and from an external environment.

20. The method of claim 17, wherein:
the structure comprises a lid and a body, different portions of at least one of the lid and the body forming the thermomechanical regions; and
channels in the structure form the one or more thermal energy transfer devices.

21. The method of claim 17, wherein the one or more thermal energy transfer devices are configured to receive thermal energy resulting from heat originating from one or more components internal to a system or from an external environment.

22. The method of claim 17, wherein:
the method further comprises actively generating thermal energy;
the one or more thermal energy transfer devices receive the actively-generated thermal energy; and
the one or more shape-memory materials are configured to cause the shape of the structure to change based on the actively-generated thermal energy.

23. The method of claim 22, wherein the actively-generated thermal energy is generated remote from the structure and is provided to the structure through a port.

24. The method of claim 17, wherein the one or more thermal energy transfer devices comprise one or more oscillating heat pipes.
